(19) United States
(12) Patent Application Publication
(10) Pub. No.: US 2009/0106970 A1
(43) Pub. Date: Apr. 30, 2009

(54) Lithium-Ion Rechargeable Battery Preparation

(76) Inventors: YiWei Fan, Shenzhen (CN); Kai Wang, Shenzhen (CN); Lei Lei, Shenzhen (CN); Cheng Zeng, Shenzhen (CN)

Correspondence Address: GREENBERG TRAURIG, LLP (SV);IP DOCKETING, 2450 COLORADO AVENUE, SUITE 400E, SANTA MONICA, CA, 90404, US

(21) Appl. No.: 12/198,087

(22) Filed: Aug. 25, 2008

(30) Foreign Application Priority Data
Oct. 26, 2007 (CN) 200710165372.X

(51) Int. Cl. H01M 6/00; H02J 7/04

(52) U.S. Cl. 29/623.2; 320/155

(57) ABSTRACT

A lithium-ion rechargeable battery preparation methods that utilizes a double-injection method to reduce the thickening of the solid electrolyte interface (SEI) membrane caused by electrolyte additives such as lithium bis(oxalato)borate (LiBOB). The method includes injecting a portion of the electrolyte into the battery for the formation process and injecting a second portion of the electrolyte into the battery with the additives after the formation process.

### FIELD OF THE INVENTION

The present invention relates to a preparation method for lithium-ion rechargeable batteries.

### BACKGROUND

As lithium ion rechargeable battery industry continues to grow, there has been ever increasing demand for better battery performance. The performance of a lithium battery is reflected in its storage property at high temperatures, discharge performance at low temperatures, discharge rate and cycle life. Factors affecting battery performance include the electrode material, battery preparation process and electrolyte. In recent years, lithium bis(oxalato)borate (LiBOB) has been used as a new electrolyte additive, improving battery performance at high temperature and the cycle life. The patent application US2005026044 discloses a battery electrolyte containing LiBOB in γ-butyrolactone and low viscosity solvent. Japanese application JP2006040896 discloses a lithium battery using LiBOB additives which tolerates relatively high temperature.

The existing technology using the LiBOB additive, however, has its shortcomings. First, there is an irreversible capacity increases during the initial charge-discharge cycle. Second, the low-temperature discharge capacity decreases. Third, the battery discharge rate decreases. The present invention improves secondary lithium battery performance with improved battery preparation method.

### SUMMARY

The current invention describes a method for preparing lithium-ion rechargeable battery. This method comprises the following steps: Place the electrode assembly into the battery casing and then place a first portion of electrolyte into the casing and temporarily seal the casing for the formation process. After the formation process, add an additive into a second portion of electrolyte and place the second portion of electrolyte in the casing. Seal the casing to finish the battery preparation.

### BRIEF DESCRIPTION OF THE DRAWINGS

FIG. 1 illustrates the center thickness, measured at room temperature, of batteries made using the methods in Examples 1-3 and Controls 1-2 during the repeated charge/discharge cycles.

FIG. 2 illustrates the center thickness, measured at 45° C. environment, of batteries made using the methods in Examples 1-3 and Controls 1-2 during the repeated charge/discharge cycles.

### DETAILED DESCRIPTION

This invention describes a new and improved method for making lithium-ion rechargeable batteries. The method includes placing battery electrodes into the battery casing and injecting electrolyte into the casing. The electrolyte injection is carried in two steps. In the first step, part of the electrolyte is injected into the battery casing and the casing is then temporarily sealed for the formation process. Certain additives such as LiBOB are then added into the remaining electrolyte and the mixture is injected into the battery casing.

This method prevents the additives such as LiBOB from thickening the solid electrolyte interface (SEI) during the battery formation process and results in a better battery performance. The LiBOB-induced thickening of the SEI membrane leads to a loss of the cycle capacity as reassured by the battery capacity retaining ratio. The SEI thickening also lowers the discharge capacity at low temperatures, slows the discharge rate, and shortens the cycle life of the battery. Without LiBOB during the first injection of electrolyte, the formation of the SEI membrane is not affected by LiBOB and prevents the LiBOB-induced thickening of SEI. After the formation process, LiBOB is added through the second injection to improve the electrical property of the battery.

The amount of electrolyte used in the first injection is 40-90% of the total electrolyte, while the second injection uses 10-60% of the total electrolyte Optimally, the first injection should use 50-70% of the total electrolyte while the second 30-50%. The amount of additives used in the present invention ranges from 0.1-3.0% of the electrolyte in weight.

The method for implementing the formation process is known to a person of ordinary skill in the art. For example, the formation process may involve charging the temporarily sealed battery casing using 55-220 mA current for 6-10 hours so that the voltage of the battery reaches 3.5-4.0 Volts. The purpose of the formation process is to form steady and dense SEI membrane.

The electrolyte used in the present invention may include one or more of the following compounds: lithium hexafluorophosphate (LiPF₆), lithium perchlorate (LiClO₄), lithium tetrafluoroborate (LiBF₄), lithium hexafluoroarsenate (LiAsF₆), lithium hexafluorosilicate (LiSiF₆), lithium tetraphenylborate (LiB(C₆H₅)₄), lithium chloride (LiCl), lithium bromide (LiBr), lithium aluminum tetrachloride (LiAlCl₄), lithium tri(trifluoromethenesulfonyl)methene (LiC(CF₃SO₂)₃), lithium trifluoromethenesulfonate (LiCF₃SO₃), and lithium bis(trifluoromethylsulfonyl)imide (LiN(CF₃SO₂)₂).

The solvent used in the electrolyte can be one or more of the following compounds: ethylene carbonate (EC), diethyl carbonate (DEC), dimethyl carbonate (DMC), ethyl methyl carbonate (EMC), propylene carbonate (PC), methyl formate (MF), methyl acrylate (MA), methyl butyrate (MB), ethyl acetate (EA), ethylene sulfate (ES), propylene sulfite (PS), dimethyl sulfide (DMS), diethyl sulfate (DES), and tetrahydrofuran (THF).

The concentration of the electrolyte in the solvent is 0.1-2 mol/L, with the optimal concentration being 0.8-1.2 mol/L.

### EXAMPLE 1

1. Cathode Preparation

Dissolve 60 grams of poly(vinylidene difluoride) (PVDF) in 2000 grams of N-methylpyrrolidone (NMP) to obtain the adhesive solution. Mix 1900 grams of lithium cobaltate (LiCoO₂) and 40 grams of acetylene carbon black. Add the mixture into the adhesive solution and evenly mix to obtain the cathode paste. Use a paste machine to evenly coat the cathode paste on both sides of an aluminum foil. Heat the coated foil to 150° C. inside a vacuum chamber for one hour. Roll and cut the foil into 485 mm×44 mm×125 μm cathodes, each containing approximately 8 grams of LiCoO₂.

2. Anode Preparation

Mix 950 grams of graphite, 20 grams of carbon fiber and 30 grams of styrene-butadiene rubber (SBR). Add 1,500 ml of water and mix thoroughly to obtain the anode paste. Use a paste machine to evenly coat both sides of a copper foil with the anode paste. After heating in the vacuum at 125° C. for one hour, roll and cut the foil into anodes with the dimensions 500 mm×45 mm×130 μm, each containing four grams of graphite.

3. Battery Assembly

Wrap a pair of the cathode and anode with 20-micron thick polypropylene/polyethylene/polypropylene three-layer composite film into a square-shaped electrode group. Place the electrode group into a 5×34×50 mm aluminum battery casing.

Make the electrolyte solution by dissolving LiPF₆ at 1 molar concentration in a solvent made of ethylene carbonate (EC), diethyl carbonate (DEC) and a diethyl carbonate (EMC) in a mass ratio of 1:1:1. In an argon environment, inject 2.2 grams of the electrolyte solution into the battery casing with the electrode group. Seal the injection hole on the casing temporarily with a rubber pad and charge the battery with 110 mA current for 8 hours for the formation process. The battery voltage after the formation should be around 3.5-4.0 V.

Add 0.044 grams of LiBOB into 1.256 grams of the electrolyte solution. Unseal the battery casing by removing the rubber pad and Inject the LiBOB-containing electrolyte into the casing as the second electrolyte injection. Seal the casing permanently to obtain LP053450 type lithium-ion battery. The battery's design capacity is 1100 mAh.

### EXAMPLE 2

Make a lithium-ion battery according to Example 1, except that 1.75 grams of the electrolyte solution was injected for the first injection and that 1.7465 grams of electrolyte with 0.0035 grams of LiBOB is injected for the second electrolyte injection.

### EXAMPLE 3

Make a lithium-ion battery according to Example 1, except that 2.45 grams of the electrolyte solution was injected for the first injection and that 0.95 grams of electrolyte with 0.1 grams of LiBOB is injected for the second electrolyte injection.

Control 1

Make a lithium-ion battery according to Example 1, except that no LiBOB is added for the second injection of the electrolyte.

Control 2

Make a lithium-ion battery according to Example 1, except that LiBOB is added into the first electrolyte injection instead of the second injection.

Performance Test

1. Battery Capacity Test

Make 5 batteries according to Example 1-3 and Control 1 & 2. Measure the battery capacity of the 5 batteries using a BS-9300 rechargeable battery testing device at room temperature and with relative humidity of 25-85%. Use constant current and constant voltage to charge the battery to 4.2 V. Discharge the battery with constant current to 3.1 V. The charge/discharge current is 1 C. The test data for the five batteries are listed in Table 1 below.

TABLE 1
Battery Capacity Measurement

| | Capac- | Capac- | Capac- | Capac- | Capac- | |
|---|---|---|---|---|---|---|
| | ity | ity | ity | ity | ity | |
| | 1 | 2 | 3 | 4 | 5 | Average |
| Example 1 | 1095 | 1098 | 1092 | 1099 | 1103 | 1097.4 |
| Example 2 | 1098 | 1101 | 1095 | 1103 | 1091 | 1097.6 |
| Example 3 | 1093 | 1095 | 1099 | 1090 | 1095 | 1094.4 |
| Control 1 | 1092 | 1011 | 1089 | 1098 | 1104 | 1097.8 |
| Control 2 | 1062 | 1059 | 1067 | 1055 | 1063 | 1061.2 |

2. High-Temperature Storage Test

First measure the initial capacity and initial thickness of the five batteries at room temperature. Then charge the batteries to 4.2 V and store the charged batteries at 85° C. in a temperature and humidity-controlled box for 48 hours. Afterwards, place the batteries at room temperature for two hours before measuring their thickness and resistance. Subsequently, discharge the batteries using 1 C to 3.1V and measure their discharge capacity as a measurement of the retained capacities of the batteries. The test data are shown in Table 2.

TABLE 2
High-Temperature Storage

| | | | Thickness | Capacity | | | |
|---|---|---|---|---|---|---|---|
| | Initial | Initial | after | after | Resistance | Capacity | Thickness |
| | Capacity | Thickness | Storage | Storage | Increase | Recovery | Increase |
| | (mAh) | (mm) | (mm) | (mAh) | (%) | (%) | (%) |
| Example 1 | 1095 | 5.56 | 5.87 | 971.4 | 12.05 | 5.58 | 5.58 |
| Example 2 | 1097 | 5.53 | 5.94 | 935.3 | 14.31 | 7.41 | 7.41 |
| Example 3 | 1093 | 5.57 | 5.92 | 970.9 | 10.57 | 6.28 | 12.45 |
| Control 1 | 1103 | 5.54 | 6.23 | 882.2 | 18.55 | 12.45 | 9.53 |
| Control 2 | 1064 | 5.56 | 5.99 | 918.4 | 11.74 | 7.73 | 5.58 |

3. Low-Temperature Discharge Property Test

Place a charged battery made according to one of the methods described in Example 1-3 and Control 1 & 2 at −10° C. in a temperature and humidity-controlled box for 90 minutes. Discharge the battery using 1 C or 0.2 C current to 2.75 V and record the respective discharge capacity. Charge the battery in room temperature to 4.2 V using constant current and constant voltage and then place the battery in constant-temperature and constant-humidity box at −20° C. for 90 minutes. Again discharge the battery using 1 C or 0.2 C current to 2.75 V and measure the respective discharge capacity. Table 3 below shows the data of this test.

TABLE 3
Low-Temperature Discharge Capacity

| | −10° C. | | −20° C. | |
|---|---|---|---|---|
| | Capacity | | Capacity | |
| | @1 C | Capacity@0.2 C | @1 C | Capacity@0.2 C |
| | (mAh) | (mAh) | (mAh) | (mAh) |
| Example 1 | 632 | 1039 | 159 | 918 |
| Example 2 | 606 | 1024 | 135 | 914 |
| Example 3 | 636 | 1036 | 145 | 921 |
| Control 1 | 644 | 1045 | 171 | 925 |
| Control 2 | 482 | 1005 | 76 | 648 |

4. The Discharge Rate Test

This test is also conducted on each of the five batteries in Example 1-3 and Control 1-2, using a BS-9300 rechargeable battery testing device at room temperature and with relative humidity of 25-85%. First charge the battery using 1 C current to 4.2 V. Then discharge the battery with 0.5 C current to 3.1 V. Record the discharge capacity. Repeat the test using 1 C, 2 C, 3 C discharge current, respectively. The rate of discharge measurements are shown Table 4.

TABLE 4
The Rate of Discharge Measurements

| | Discharge Capacity (mAh) | | | | | Discharge Rate (%) | | | |
|---|---|---|---|---|---|---|---|---|---|
| | 0.2 C | 0.5 C | 1 C | 2 C | 3 C | 0.5 C/0.2 C | 1 C/0.2 C | 2 C/0.2 C | 3 C/0.2 C |
| Example 1 | 1140.2 | 1122.5 | 1098.0 | 1047.5 | 935.7 | 98.45 | 97.82 | 95.40 | 89.33 |
| Example 2 | 1136.0 | 1091.8 | 1070.9 | 1011.1 | 891.8 | 96.10 | 98.09 | 94.41 | 88.21 |
| Example 3 | 1134.2 | 1098.5 | 1085.1 | 1039.3 | 923.7 | 96.34 | 96.67 | 94.65 | 88.19 |
| Control 1 | 1138.1 | 1120.1 | 1086.6 | 1053.7 | 932.4 | 98.43 | 97.01 | 96.97 | 88.49 |
| Control 2 | 1097.8 | 1047.4 | 983.0 | 908.9 | 772.4 | 95.41 | 93.85 | 92.46 | 84.99 |

5. The Cycle Capacity Test

This test is also conducted using a BS-9300 rechargeable battery testing device at room temperature and at 45° C. environment, respectively, and with a relative humidity of 25-85%. The battery is charged using 1 C current to 4.2 V and discharged using the same current to 3.1 V. A computer records the capacity at each charge/discharge cycle. Manually measure battery thickness every 50 cycles. Calculate the cycle discharge capacity maintenance rate using the following formula:

Capacity Retaining Rate=Discharge Capacity/Initial Capacity×100%. Table 5 and 6 show the results normalized to the initial capacity (i.e., capacity at Cycle No. 1).

TABLE 5
Cycle Capacity Test at Room Temperature

| | Cycle No. | | | | | | | | | | | | |
|---|---|---|---|---|---|---|---|---|---|---|---|---|---|
| | 1 | 5 | 10 | 50 | 100 | 150 | 200 | 250 | 300 | 350 | 400 | 450 | 500 |
| Example 1 | 1.0000 | 0.9961 | 0.9857 | 0.9769 | 0.9482 | 0.9277 | 0.9233 | 0.8947 | 0.8854 | 0.8828 | 0.8747 | 0.8710 | 0.8502 |
| Example 2 | 1.0000 | 0.9922 | 0.9888 | 0.9800 | 0.9431 | 0.9263 | 0.9184 | 0.8800 | 0.8744 | 0.8670 | 0.8551 | 0.8455 | 0.8317 |
| Example 3 | 1.0000 | 0.9937 | 0.9845 | 0.9772 | 0.9408 | 0.9239 | 0.9176 | 0.8869 | 0.8785 | 0.8721 | 0.8634 | 0.8594 | 0.8468 |
| Control 1 | 1.0000 | 0.9989 | 0.9883 | 0.9703 | 0.9098 | 0.8826 | 0.8686 | 0.8358 | 0.8072 | 0.7862 | 0.7643 | 0.7557 | 0.7320 |
| Control 2 | 1.0000 | 0.9904 | 0.9874 | 0.9825 | 0.9307 | 0.9165 | 0.9062 | 0.8881 | 0.8764 | 0.8596 | 0.8508 | 0.8447 | 0.8397 |

TABLE 6
Cycle Capacity Test at 45° C.

| | Cycle No. | | | | | | | | | | | | |
|---|---|---|---|---|---|---|---|---|---|---|---|---|---|
| | 1 | 5 | 10 | 50 | 100 | 150 | 200 | 250 | 300 | 350 | 400 | 450 | 500 |
| Example 1 | 1.0000 | 0.9971 | 0.9896 | 0.9627 | 0.9415 | 0.9382 | 0.9174 | 0.9048 | 0.8973 | 0.8871 | 0.8801 | 0.8704 | 0.8658 |
| Example 2 | 1.0000 | 0.9956 | 0.9896 | 0.9634 | 0.9434 | 0.9308 | 0.9162 | 0.9024 | 0.8854 | 0.8787 | 0.8602 | 0.8469 | 0.8311 |
| Example 3 | 1.0000 | 0.9967 | 0.9873 | 0.9642 | 0.9426 | 0.9355 | 0.9158 | 0.9021 | 0.8903 | 0.8815 | 0.8699 | 0.8532 | 0.8376 |
| Control 1 | 1.0000 | 0.9972 | 0.9806 | 0.9580 | 0.9474 | 0.9219 | 0.8995 | 0.8809 | 0.8569 | 0.8345 | 0.8126 | 0.7946 | 0.7717 |
| Control 2 | 1.0000 | 0.9968 | 0.9876 | 0.9637 | 0.9455 | 0.9353 | 0.9169 | 0.9065 | 0.8860 | 0.8773 | 0.8616 | 0.8429 | 0.8382 |

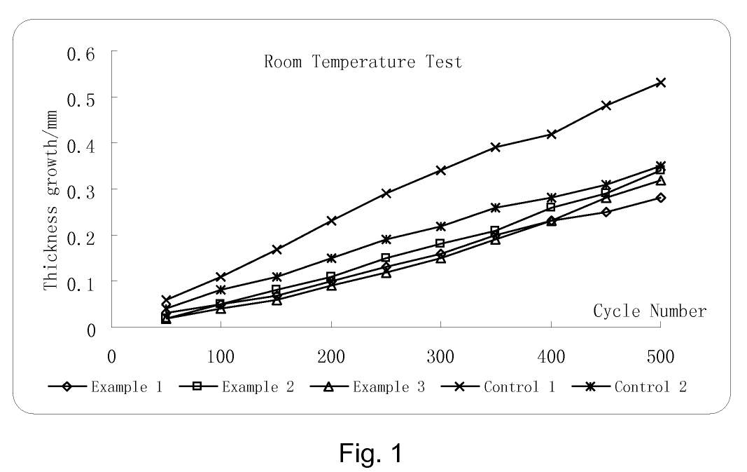

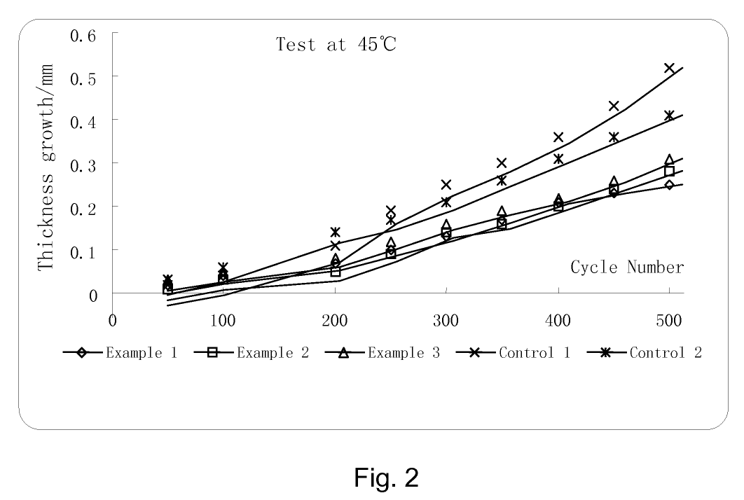

From the data shown in Tables 1-6 and FIGS. 1 and 2, it can be concluded the lithium-ion rechargeable batteries prepared using the present invention exhibit consistently enhanced performance, including battery capacity, high-temperature storage ability, low-temperature discharge capacity, and cycle capacity.

What is claimed is:

1. A method for making lithium-ion rechargeable batteries comprising:
placing the electrode assembly into the battery casing;
placing a first portion of electrolyte into the casing;
sealing the casing and undergoing the formation process;
unsealing the casing and placing a second portion of electrolyte into the casing, wherein the sum of said first portion and second portion of electrolyte forms the total battery electrolyte and wherein said second portion of electrolyte contains an additive that enhances the battery performance; and
sealing the battery casing.

2. The method of claim 1, wherein said additive is lithium bis(oxalato)borate (LiBOB).

3. The method of claim 1, wherein said first portion of electrolyte is 40-90% of said total battery electrolyte.

4. The method of claim 1, wherein said first portion of electrolyte is 50-70% of said total battery electrolyte.

5. The method of claim 1, wherein said first portion of electrolyte is 30-50% of said total battery electrolyte.

6. The method of claim 1, wherein the formation process comprising charging the temporarily sealed battery with 55-220 mA current for 6-10 hours so that the voltage of the battery reaches 3.5-4.0 V.

7. The method of claim 1, wherein said electrolyte uses one or more of the following compounds: lithium hexafluorophosphate (LiPF₆), lithium perchlorate (LiClO₄), lithium tetrafluoroborate (LiBF₄), lithium hexafluoroarsenate (LiAsF₆), lithium hexafluorosilicate (LiSiF₆), lithium tetraphenylborate (LiB(C₆H₅)₄), lithium chloride (LiCl), lithium bromide (LiBr), lithium aluminum tetrachloride (LiAlCl₄), lithium tri(trifluoromethenesulfonyl)methene (LiC(CF₃SO₂)₃), lithium trifluoromethenesulfonate (LiCF₃SO₃), and lithium bis(trifluoromethylsulfonyl)imide (LiN(CF₃SO₂)₂).

8. The method of claim 1, wherein said electrolyte uses one or more of the following solvents: ethylene carbonate (EC), diethyl carbonate (DEC), dimethyl carbonate (DMC), ethyl methyl carbonate (EMC), propylene carbonate (PC), methyl formate (MF), methyl acrylate (MA), methyl butyrate (MB), ethyl acetate (EA), ethylene sulfate (ES), propylene sulfite (PS), dimethyl sulfide (DMS), diethyl sulfate (DES), and tetrahydrofuran (THF).

9. The method of claim 1, wherein said electrolyte contains 0.5-2 mol/L electrolyte compound in a solvent.
